(19) United States
(12) Patent Application Publication
(10) Pub. No.: US 2022/0072980 A1
(43) Pub. Date: Mar. 10, 2022

(54) DOUBLE-FOLDING UNLOCKING DEVICE OF REAR SEAT FOR VEHICLE

(71) Applicants: HYUNDAI TRANSYS INC, Chungcheongnam-do (KR); Daechang Seat Co.,LTD-Dongtan, Gyeonggi-do (KR)

(72) Inventors: Jun Sik HWANG, Gyeonggi-do (KR); Kyeong Ju KIM, Gyeonggi-do (KR); Hwa Young MUN, Gyeonggi-do (KR); Cheol Hwan YOON, Gyeonggi-do (KR); Jung Bin LEE, Gyeonggi-do (KR); Chan Ki CHO, Gwangju (KR); Myeong Su LEE, Gyeonggi-do (KR); Sin Chan YANG, Gyeonggi-do (KR); Jeon II KANG, Chungcheongnam-do (KR)

(21) Appl. No.: 17/446,890

(22) Filed: Sep. 3, 2021

(30) Foreign Application Priority Data
Sep. 4, 2020 (KR) 10-2020-0112971

(51) Int. Cl. B60N 2/30; B60N 2/90

(52) U.S. Cl. CPC B60N 2/3011; B60N 2002/952; B60N 2/938

(57) ABSTRACT

The present disclosure provides a double-folding unlocking device of a rear seat for a vehicle. The double-folding unlocking device of a rear seat is capable of preventing the occurrence of excessively tight fitting and deformation of components due to excessively tight contact between bracket members when a seatback is rotated in an opposite direction while the seatback is folded or unfolded.

This application claims under the benefit of Korean Patent Application No. 10-2020-0112971, filed on Sep. 4, 2020, the entireties of which are hereby incorporated herein by reference.

### BACKGROUND

### (a) Technical Field

The present disclosure relates to a double-folding unlocking device of a rear seat for a vehicle, and more particularly to a double-folding unlocking device of a rear seat capable of preventing the occurrence of excessively tight fitting and deformation of components due to excessively tight contact between bracket members when a seatback is rotated in an opposite direction while the seatback is folded or unfolded.

### (b) Background Art

In general, a seat of a vehicle is composed of a seat cushion, which is mounted to a floor panel of a vehicle body, and a seatback, which is rotatably mounted to the seat cushion.

The seatback is rotatably mounted to the rear end of the seat cushion via a recliner, and the angle of the seatback is adjusted by the recliner.

The recliner interconnects the lower portion of the seatback and the rear portion of the seat cushion. During operation thereof, the recliner unlocks to permit rotation of the seatback so that the seatback is folded toward the seat cushion or is reclined backwards.

In the case of a double-folding rear seat, due to the operation of the recliner, the seatback is rotated and folded toward the seat cushion, and thereafter the seat cushion is separated from the floor panel of the vehicle body and rotated toward a front seat.

FIGS. 7 and 8 are views illustrating the operation of a conventional double-folding unlocking device of a rear seat. Specifically, FIG. 7 illustrates the operation of the conventional double-folding unlocking device when the seatback is folded, and FIG. 8 illustrates the operation of the conventional double-folding unlocking device when the seatback is unfolded.

Referring to FIG. 7, the conventional double-folding unlocking device includes a cushion hinge bracket 1, which is mounted to a seat cushion frame, a back hinge bracket 2, which is mounted to a seatback frame, and a link unit 3, which is mounted to the cushion hinge bracket 1 and unlocks a double-folding locking latch (not shown) in a manner of being interlocked with the rotational operation of the back hinge bracket 2.

Although not illustrated in the drawings, the double-folding locking latch is mounted to the lower portion of the seat cushion, and serves to secure the seat cushion to the floor panel of the vehicle body so as to interrupt rotational operation of the rear portion of the seat cushion in a forward direction (i.e. a double-folding operation).

The double-folding locking latch is connected to the link unit 3 via a cable (not shown). When the link unit 3 pulls the cable, the double-folding locking latch is released. When the latch is released, the double-folding operation of the seat cushion becomes possible.

Referring to FIGS. 7 and 8, the link unit 3 is composed of a first link bracket 4 and a second link bracket 5, which are assembled to the cushion hinge bracket 1 by means of a rotation pin 7. The first link bracket 4 is interlocked with rotation of the back hinge bracket 2 by means of a hinge pin 6 provided at one end thereof. When the seatback is folded, the second link bracket 5 is rotated integrally with the first link bracket 4, and when the seatback is unfolded, only the first link bracket 4 is rotated.

However, while the back hinge bracket 2 is rotated in a direction for folding the seatback (i.e. a folding direction), when the seatback is rotated in the opposite direction, i.e. an unfolding direction, specifically, when the seatback is rotated in the unfolding direction at stage \textcircled{4} in FIG. 7 while the seatback is folded, the lower end of the back hinge bracket 2 tightly contacts the hinge pin 6. As shown in FIG. 9A, excessively tight fitting and deformation occur in components due to excessively tight contact between the back hinge bracket 2 and the hinge pin 6.

In addition, while the back hinge bracket 2 is rotated in the direction for unfolding the seatback (i.e. the unfolding direction), when the seatback is rotated in the opposite direction, i.e. the folding direction, specifically, when the seatback is rotated in the folding direction at stage \textcircled{4} in FIG. 8 while the seatback is unfolded, the lower end of the back hinge bracket 2 tightly contacts the hinge pin 6. As shown in FIG. 9B, excessively tight fitting and deformation occur in components due to excessively tight contact between the back hinge bracket 2 and the hinge pin 6.

The above information disclosed in this Background section is only for enhancement of understanding of the background of the invention and therefore it may contain information that does not form the related art that is already known in this country to a person of ordinary skill in the art.

### SUMMARY OF THE INVENTION

The present invention has been made in an effort to solve the above-described problems associated with the related art, and it is an object of the present invention to provide a double-folding unlocking device of a rear seat for a vehicle, which is configured to secure movability of a bracket member that is interlocked with a back hinge bracket of a seatback frame, thereby preventing the occurrence of excessively tight fitting and deformation of components due to excessively tight contact between the bracket member and the back hinge bracket when a seatback is rotated in an opposite direction while the seatback is folded or unfolded.

However, the objects to be accomplished by the invention are not limited to the above-mentioned object. The objects of the invention will be more apparent from the following description, and will be realized by means of the elements and combinations thereof pointed out in the appended claims.

In one aspect, the present invention provides a double-folding unlocking device of a rear seat for a vehicle, the double-folding unlocking device including a cushion hinge bracket mounted to a rear portion of a seat cushion frame so as to rotate integrally with the seat cushion frame, a lever bracket assembled to the cushion hinge bracket so as to be rotatable about a first rotation shaft, a link bracket having a lower portion rotatably linked to an upper arm of the lever bracket and an upper portion formed to be interlocked with rotation of a back hinge bracket mounted to a lower portion of a seatback frame, and a latch release cable assembly linked at a rear end thereof to a front arm of the lever bracket to unlock the seat cushion frame from a floor panel of a vehicle body when the lever bracket rotates.

According to the embodiment of the present invention, the lower portion of the link bracket may be linked to the upper arm so as to be rotatable about a second rotation shaft assembled to the upper arm, and the upper portion of the link bracket may be provided with a hinge pin at a position opposite the second rotation shaft. When the back hinge bracket rotates, the hinge pin may be pushed and moved by a lower portion of the back hinge bracket.

The lever bracket may be provided with a latching piece formed at the upper end of the upper arm. When the back hinge bracket rotates in a folding direction of a seatback, the link bracket may catch on the latching piece and may rotate integrally with the lever bracket. In addition, when the back hinge bracket rotates in an unfolding direction of the seatback, the link bracket may not catch on the latching piece and may rotate about the second rotation shaft.

In one aspect, according to the embodiment of the present invention, the double-folding unlocking device may further include a lever-returning spring having an upper end linked to the front arm of the lever bracket and a lower end linked to the cushion hinge bracket. When the lever bracket rotates together with the link bracket, the lever-returning spring may generate elastic restoring force.

In another aspect, the double-folding unlocking device may further include a link-returning spring fitted around the second rotation shaft, the link-returning spring having one end linked to the link bracket and an opposite end linked to the latching piece. When the link bracket rotates about the second rotation shaft, the link-returning spring may generate elastic restoring force.

The lever bracket may be provided with a rear arm formed opposite the front arm with respect to the first rotation shaft. When the lever bracket is returned by the lever-returning spring, the rear arm may come into contact with a stopper formed at the cushion hinge bracket and may stop moving.

Other aspects and preferred embodiments of the invention are discussed infra.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIGS. 1 and 2 are views illustrating a double-folding unlocking device of a rear seat according to the present invention;

FIGS. 3A to 3D are a view illustrating the operational process of the double-folding unlocking device according to the present invention during folding of a seatback;

FIGS. 4A to 4D are a view illustrating the operational process of the double-folding unlocking device according to the present invention during unfolding of the seatback;

FIG. 5 is a view illustrating the operational state between stage of FIG. 3C and stage of FIG. 3D;

FIG. 6 is a view illustrating the operational state between stage of FIG. 4C and stage of FIG. 4D;

FIGS. 7 and 8 are views illustrating the operational process of a conventional double-folding unlocking device of a rear seat; and

FIGS. 9A and 9B are a view illustrating a problem with the conventional double-folding unlocking device of a rear seat.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes, will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. Contents represented in the accompanying drawings are illustrated diagrammatically in order to easily describe the embodiments of the present invention, and the contents may be different from forms that are actually implemented.

Throughout the specification, when an element is referred to as “comprising” or “including” another element, the element should not be understood as excluding other elements, so long as there is no particular conflicting description, and the element may include at least one other element.

In addition, a forward-backward direction, an upward-downward direction, and a leftward-rightward direction mentioned herein represent a longitudinal direction, a vertical direction, and a lateral direction of a vehicle, respectively, unless otherwise stated.

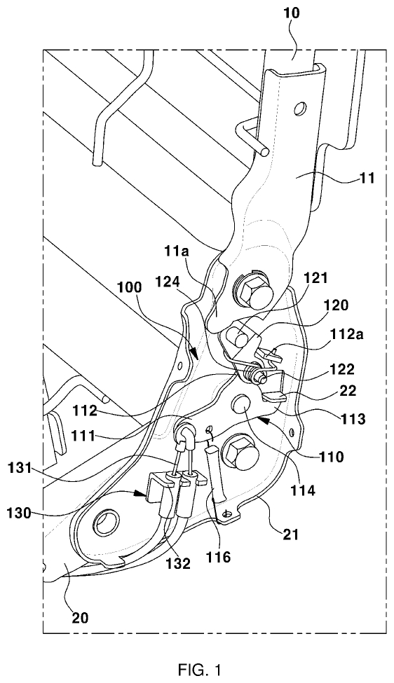

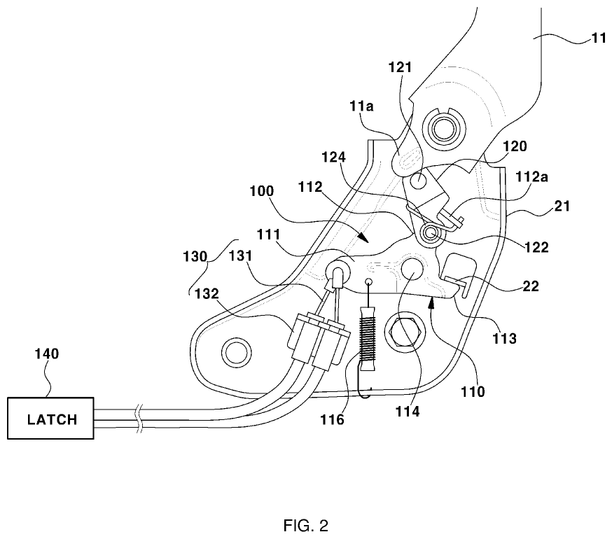

A double-folding unlocking device of a rear seat according to the present invention is configured to release a double-folding locking latch 140 when a seatback is folded and not to release the double-folding locking latch 140 when the seatback is unfolded. As shown in FIGS. 1 and 2, the double-folding unlocking device of a rear seat according to the present invention includes a lever assembly 100, which is mounted to a cushion hinge bracket 21, and a latch release cable assembly 130, which releases the double-folding locking latch 140 by means of the lever assembly 100.

The latch 140 is mounted to the lower portion of the seat cushion, and serves to secure the seat cushion to a floor panel of the vehicle body and to prevent the rear portion of the seat cushion from rotating forwards.

When the latch 140 is released, the rear portion of the seat cushion is allowed to be lifted upwards away from the floor panel of the vehicle body, making it possible to rotate the seat cushion forwards. At this time, a double-folding operation can be realized in a manner of rotating the rear portion of the seat cushion forwards in the state in which the seatback is folded onto the upper surface of the seat cushion.

The cushion hinge bracket 21 is mounted to the rear portion of the seat cushion frame 20 so as to rotate integrally with the seat cushion frame 20. The cushion hinge bracket 21 may be mounted to each of the left side and the right side of the seat cushion frame 20.

The lever assembly 100 serves to selectively operate the latch release cable assembly 130 in a manner of being interlocked with the rotational operation of a back hinge bracket 11. The lever assembly 100 includes a lever bracket 110, a link bracket 120, a lever-returning spring 116 for returning the lever bracket 110, and a link-returning spring 124 for returning the link bracket 120.

The back hinge bracket 11 is mounted to the lower portion of a seatback frame 10 so as to be moved together with the seatback frame 10. When a recliner is operated to adjust the angle of the seatback, the back hinge bracket 11 is rotated integrally with the seatback frame 10.

The lever bracket 110 is rotatably assembled to the cushion hinge bracket 21. Specifically, the lever bracket 110 is assembled to a first rotation shaft 114, which is mounted to the cushion hinge bracket 21, so as to be rotatable about the first rotation shaft 114.

The lever bracket 110 is integrally provided with a plurality of arms 111, 112 and 113 arranged in the peripheral direction thereof. Specifically, the lever bracket 110 is provided with a front arm 111, an upper arm 112, and a rear arm 113.

The front arm 111 is a portion that extends so as to be located further forward than the first rotation shaft 114. The rear end of the latch release cable assembly 130 is mounted to the front arm 111. When the lever bracket 110 is rotated in response to folding of the seatback, the front arm 111 is moved upwards to pull the latch release cable assembly 130.

The upper arm 112 is a portion that extends so as to be located higher than the first rotation shaft 114. A second rotation shaft 122 is assembled to the upper arm 112. The upper arm 112 is connected to the lower portion of the link bracket 120 via the second rotation shaft 122.

The rear arm 113 is a portion that extends so as to be located further backward than the first rotation shaft 114. The rear arm 113 is disposed opposite the front arm 111. When the seatback is completely folded and thus the lever bracket 110 returns, the rear arm 113 enables the lever bracket 110 to return to a predetermined initial position thereof.

The lower portion of the link bracket 120 is assembled to the upper arm 112 so as to be rotatable about the second rotation shaft 122. The link bracket 120 is provided at an upper portion thereof with a hinge pin 121 so as to be interlocked with the back hinge bracket 11.

The hinge pin 121 is disposed opposite the second rotation shaft 122 on the link bracket 120. The hinge pin 121 protrudes upwards from the link bracket 120 in an axial direction so as to be disposed in a trajectory along which a lower portion 11 a of the back hinge bracket 11 rotates when the seatback is folded and unfolded.

Accordingly, when the back hinge bracket 11 rotates, the lower portion 11 a of the back hinge bracket 11 comes into contact with and interferes with the hinge pin 121. The hinge pin 121 is pushed and moved by the lower portion 11a of the back hinge bracket 11, and accordingly, the link bracket 120 is rotated.

In other words, when the seatback is folded and unfolded, the hinge pin 121 moves along a predetermined circular arc path in a manner of being interlocked with the rotational operation of the back hinge bracket 11.

Specifically, when the seatback is folded, the hinge pin 121 moves along a circular arc path centered on the first rotation shaft 114, and when the seatback is unfolded, the hinge pin 121 moves along a circular arc path centered on the second rotation shaft 122.

The lever bracket 110 is provided with a latching piece 112a formed at the upper end of the upper arm 112.

The latching piece 112a may be bent from the upper end of the upper arm 112 so as to protrude in the axial direction on the cushion hinge bracket 21, thereby restricting the rotational operation of the link bracket 120.

Specifically, when the back hinge bracket 11 rotates integrally with the seatback in the folding direction, the latching piece 112a catches on and interferes with the link bracket 120, and when the back hinge bracket 11 rotates integrally with the seatback in the unfolding direction, the latching piece 112a does not interfere with the link bracket 120. To this end, the lower portion of the link bracket 120 may be assembled to the upper arm 112 at a position below the latching piece 112a.

The link bracket 120 and the lever bracket 110 rotate in a manner of being interlocked with the rotational operation of the back hinge bracket 11 during folding of the seatback, and thereafter, when folding of the seatback is completed, the link bracket 120 and the lever bracket 110 are returned to the original positions thereof by the lever-returning spring 116.

When the lever bracket 110 rotates in a latch release direction (i.e. a direction of pulling the cable) in a manner of being interlocked with the rotational operation of the back hinge bracket 11, the lever-returning spring 116 generates elastic restoring force. When the seatback is completely folded and thus the hinge pin 121 is separated from the back hinge bracket 11, the lever bracket 110 is returned to the original position thereof by the elastic restoring force of the lever-returning spring 116, and the link bracket 120 is pushed by the latching piece 112a and is returned to the original position thereof together with the lever bracket 110.

To this end, the lever-returning spring 116 is linked at the upper end thereof to the front arm 111 of the lever bracket 110, and is linked at the lower end thereof to the cushion hinge bracket 21. Accordingly, when the lever bracket 110 rotates, the lever-returning spring 116 expands and generates elastic restoring force for returning the lever assembly 100. In this case, the upper end of the lever-returning spring 116 may be disposed further backward than the rear end of the latch release cable assembly 130.

In addition, the link bracket 120 rotates in a manner of being interlocked with the rotational operation of the back hinge bracket 11 during unfolding of the seatback, and thereafter, when unfolding of the seatback is completed, the link bracket 120 is returned to the original position thereof by the link-returning spring 124.

When the link bracket 120 rotates about the second rotation shaft 122 in a manner of being interlocked with the rotational operation of the back hinge bracket 11, the link-returning spring 124 generates elastic restoring force. When the seatback is completely unfolded and thus the hinge pin 121 is separated from the back hinge bracket 11, the link bracket 120 is returned to the original position thereof by the elastic restoring force of the link-returning spring 124.

To this end, the link-returning spring 124 is fitted around the second rotation shaft 122 so as to be supported thereby, one end thereof is linked to the link bracket 120, and the other end thereof is linked to the latching piece 112a of the lever bracket 110. Accordingly, when the link bracket 120 rotates about the second rotation shaft 122, the link-returning spring 124 contracts and generates elastic restoring force for returning the link bracket 120.

In addition, in order to enable the lever bracket 110 to be more accurately returned to the predetermined initial position thereof by the lever-returning spring 116, the cushion hinge bracket 21 may be provided with a stopper 22 for restricting the rotational operation of the lever bracket 110.

When the lever bracket 110 is returned by the lever-returning spring 116, the rear arm 113 moves along a circular arc path centered on the first rotation shaft 114, and when the movement of the rear arm 113 is stopped by the stopper 22, the lever bracket 110 is returned to the initial position thereof.

The latch release cable assembly 130 may include a cable 131, which is linked at the rear end thereof to the front arm 111 of the lever bracket 110 so as to move together with the front arm 111, and a cable support frame 132, which movably supports the cable 131.

The cable 131 is linked at the front end thereof to the double-folding locking latch 140. When pulled upwards by the rotation of the lever bracket 110, the cable 131 releases the double-folding locking latch 140.

When released by the cable 131, the double-folding locking latch 140 unlocks the seat cushion frame 20 from the floor panel of the vehicle body.

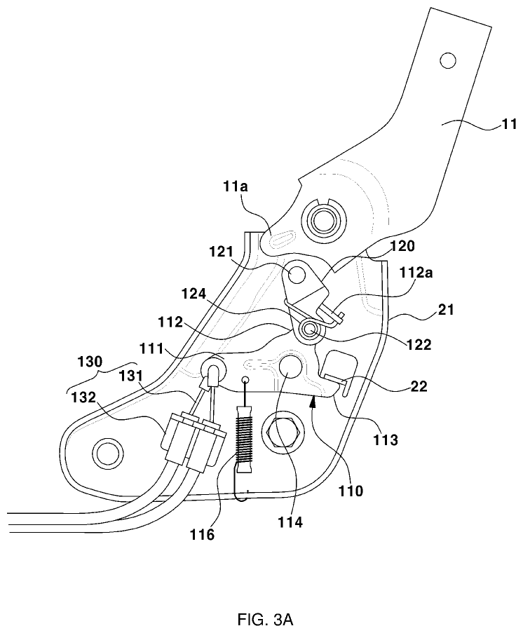

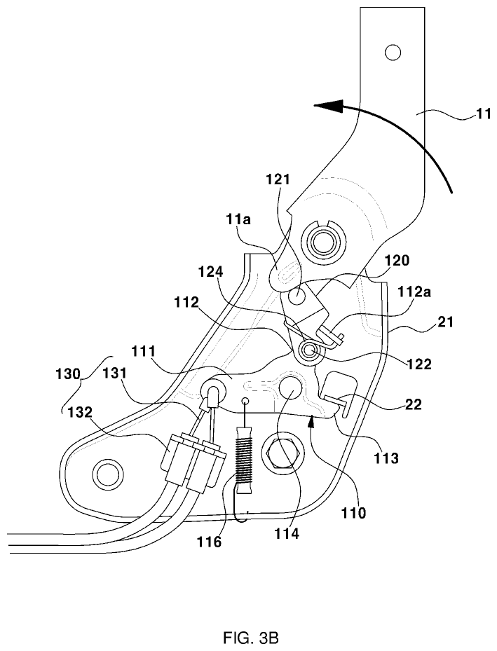

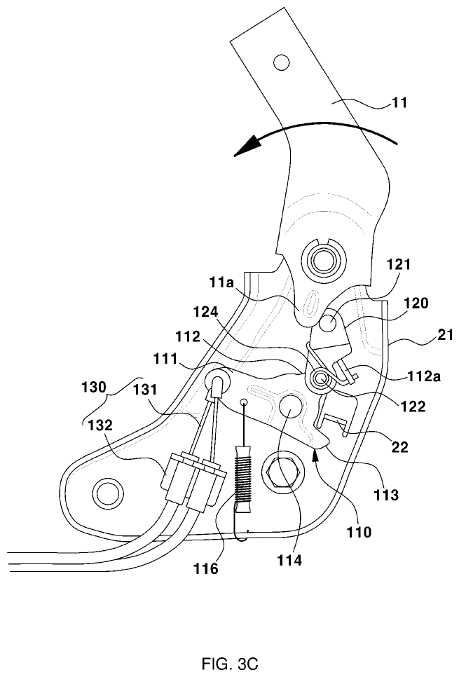

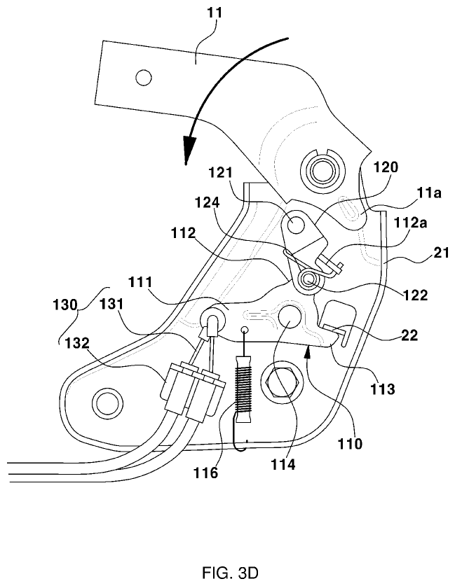

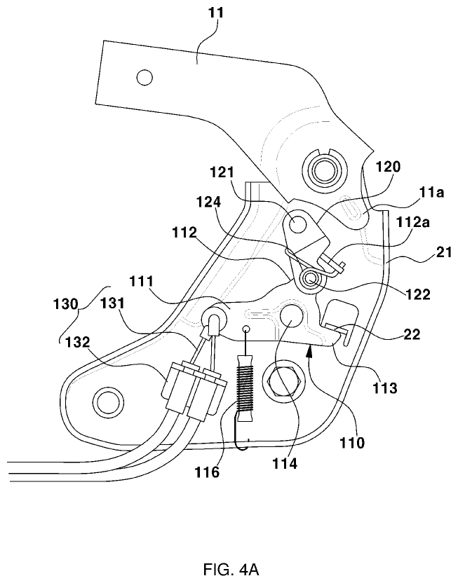

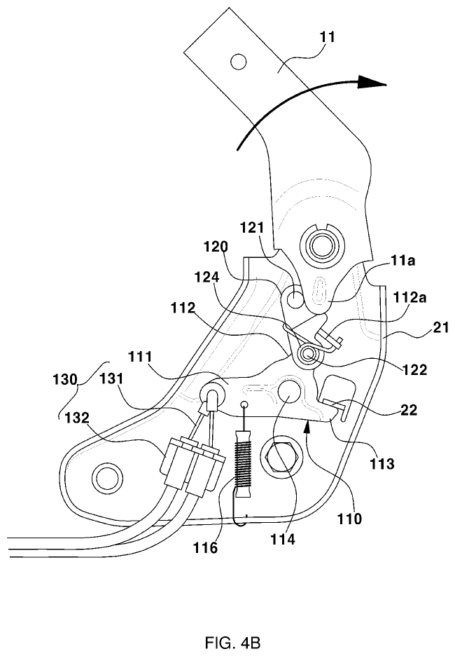

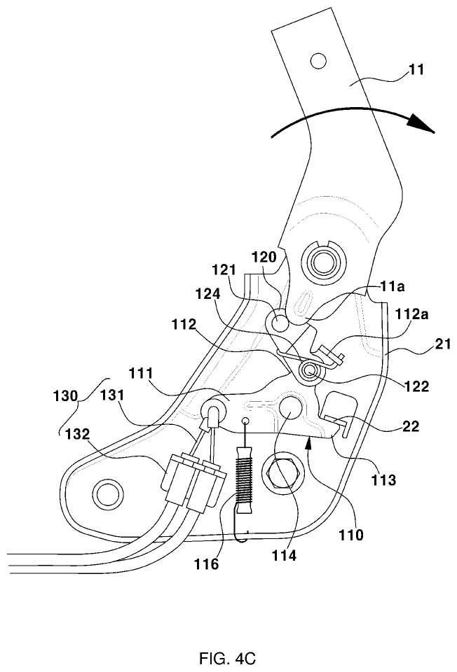

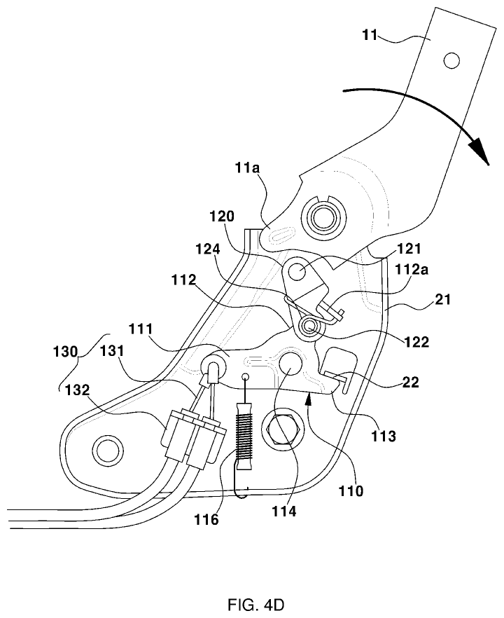

FIGS. 3A to 3D illustrates the operational process of the double-folding unlocking device of a rear seat according to the present invention during folding of the seatback, and FIGS. 4A to 4D illustrates the operational process of the double-folding unlocking device of a rear seat according to the present invention during unfolding of the seatback.

Referring to FIGS. 3A to 3D, the back hinge bracket 11 is located at an initial position in stage of FIG. 3A. When the seatback is folded, the back hinge bracket 11 is rotated as shown in stages of FIG. 3B and 3C, and is finally rotated to a folded position in stage of FIG. 3D.

The back hinge bracket 11 comes into contact with and interferes with the hinge pin 121 in stage of FIG. 3B. Subsequently, the back hinge bracket 11 pushes the hinge pin 121, whereby the link bracket 120 is rotated, as shown in stage of FIG. 3C. At this time, the link bracket 120 catches on the latching piece 112a of the lever bracket 110, and thus rotates integrally with the lever bracket 110.

At this time, the link bracket 120 and the lever bracket 110 rotate about the first rotation shaft 114, and the front arm 111 of the lever bracket 110 pulls the cable 131 to release the double-folding locking latch 140. As a result, the seat cushion enters a state in which the rear portion thereof is capable of being rotated forwards.

When the back hinge bracket 11 is rotated and reaches a position corresponding to the completely folded state of the seatback, as shown in stage of FIG. 3D, contact between the hinge pin 121 and the lower portion 11a of the back hinge bracket 11 is released, and the lever bracket 110 and the link bracket 120 are returned to the initial positions thereof by the lever-returning spring 116.

When the lever bracket 110 is returned by the lever-returning spring 116, the rear arm 113 comes into contact with the stopper 22 of the cushion hinge bracket 21, and accordingly, the lever bracket 110 does not rotate any further, and stops at the predetermined initial position thereof.

Referring to FIGS. 4A to 4D, when the seatback is unfolded from the folded position in stage of FIG. 4A, the back hinge bracket 11 is rotated as shown in stages of FIGS. 4B and 4C, and is finally rotated to an unfolded position in stage of FIG. 4D.

The lower portion 11a of the back hinge bracket 11 comes into contact with and interferes with the hinge pin 121 in stage of FIG. 4B. Subsequently, the lower portion 11a of the back hinge bracket 11 pushes the hinge pin 121, whereby the link bracket 120 is rotated, as shown in stage of FIG. 4C. At this time, the link bracket 120 does not catch on the latching piece 112a, and thus rotates independently without rotation of the lever bracket 110.

At this time, the link bracket 120 rotates about the second rotation shaft 122, and the lever bracket 110 remains at the initial position thereof.

When the back hinge bracket 11 is rotated and reaches a position corresponding to the completely unfolded state of the seatback, as shown in stage of FIG. 4D, contact between the hinge pin 121 and the lower portion 11a of the back hinge bracket 11 is released, and the link bracket 120 is returned to the initial position thereof by the link-returning spring 124.

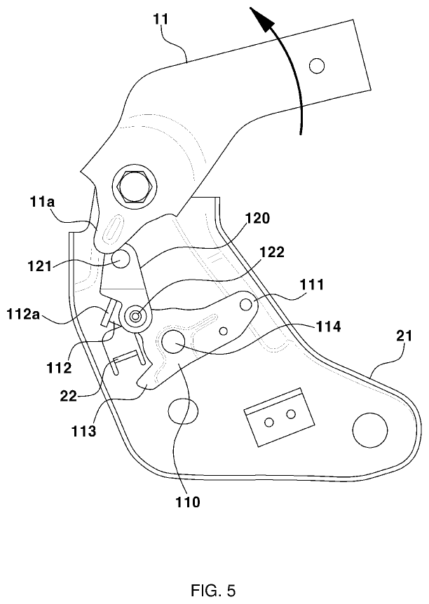

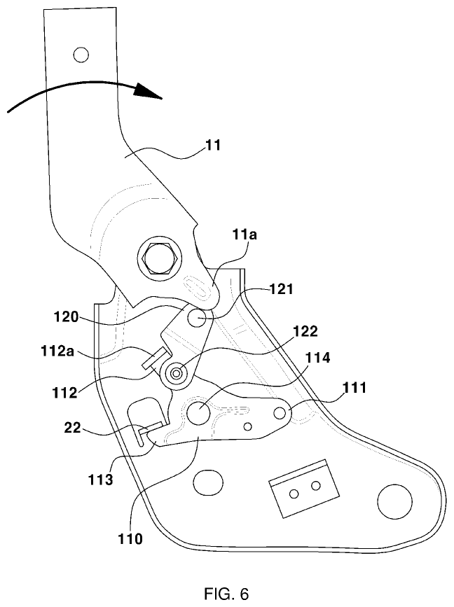

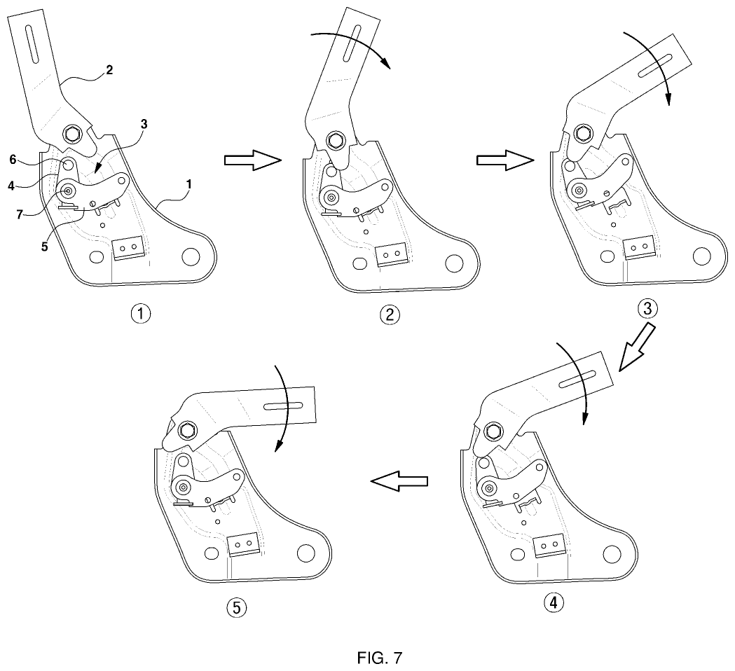

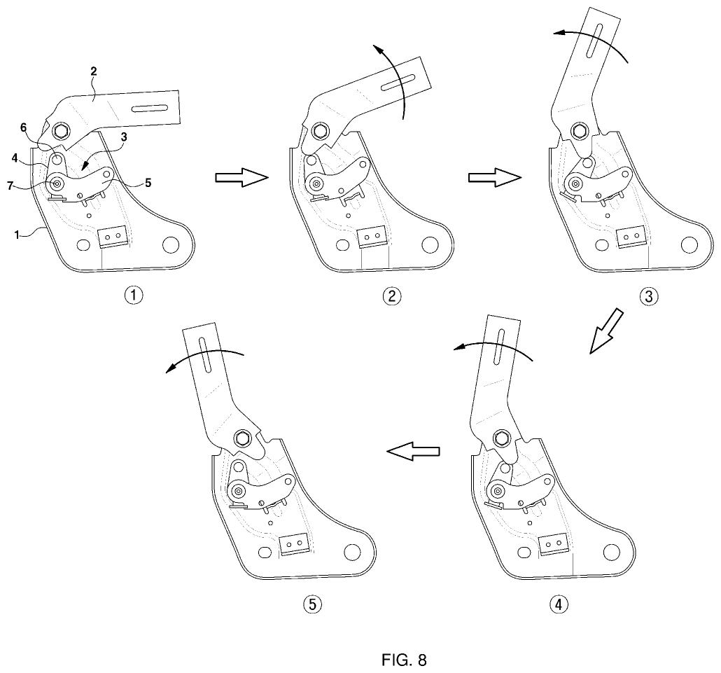

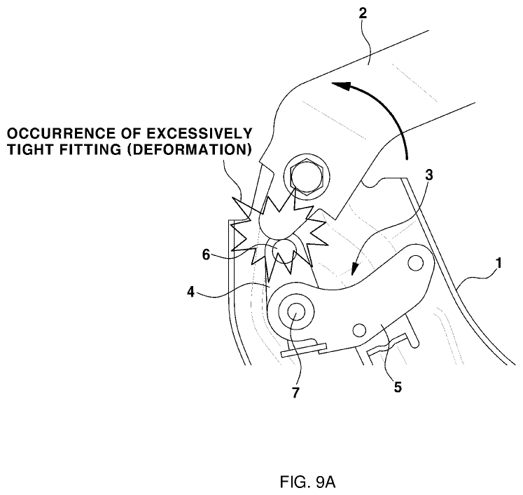

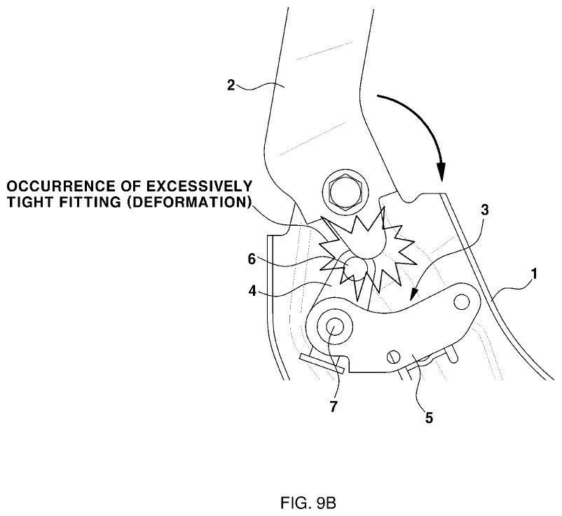

FIG. 5 is a view illustrating the operational state between stage of FIG. 3C and stage of FIG. 3D, and FIG. 6 is a view illustrating the operational state between stage of FIG. 4C and stage of FIG. 4D.

The double-folding unlocking device of a rear seat according to the present invention is disposed at each of the left side and the right side of the seat cushion. The double-folding unlocking device shown in FIGS. 5 and 6 is the device that is mounted opposite the double-folding unlocking device shown in FIG. 3A. An illustration of some components, such as the springs 116 and 124 and the cable 131, is omitted from FIGS. 5 and 6.

According to the double-folding unlocking device of the present invention, while the back hinge bracket 11 is rotated in a direction for folding the seatback, when the seatback is rotated in the opposite direction, i.e. the unfolding direction, specifically, as shown in FIG. 5, when the seatback is rotated in the unfolding direction at the operational position immediately before contact between the back hinge bracket 11 and the hinge pin 121 is released, the link bracket 120 rotates about the second rotation shaft 122, and at the same time, the lever bracket 110 rotates about the first rotation shaft 114, whereby the link bracket 120 is allowed to move downwards. As a result, it is possible to rotate the back hinge bracket 11 in the unfolding direction while preventing the occurrence of excessively tight fitting and deformation of components due to excessively tight contact between the hinge pin 121 and the back hinge bracket 11.

In addition, according to the double-folding unlocking device of the present invention, while the back hinge bracket 11 is rotated in a direction for unfolding the seatback, when the seatback is rotated in the opposite direction, i.e. the folding direction, specifically, as shown in FIG. 6, when the seatback is rotated in the folding direction at the operational position immediately before contact between the back hinge bracket 11 and the hinge pin 121 is released, the link bracket 120 rotates about the second rotation shaft 122, and at the same time, the lever bracket 110 rotates about the first rotation shaft 114, whereby the link bracket 120 is allowed to move downwards. As a result, it is possible to rotate the back hinge bracket 11 in the folding direction while preventing the occurrence of excessively tight fitting and deformation of components due to excessively tight contact between the hinge pin 121 and the back hinge bracket 11.

As described above, the double-folding unlocking device of the present invention is configured such that the lever assembly 100 is capable of rotating about the first rotation shaft 114 and the second rotation shaft 122, thereby securing movability of the link bracket 120 with respect to the back hinge bracket 11. Accordingly, it is possible to prevent excessively tight fitting and deformation of components due to excessively tight contact between the link bracket 120 and the back hinge bracket 11.

As is apparent from the above description, according to the present invention, a link bracket and a lever bracket are configured to rotate about a first rotation shaft and a second rotation shaft, whereby movability of the link bracket with respect to a back hinge bracket is secured, thus preventing excessively tight fitting and deformation of components due to excessively tight contact between the link bracket and the back hinge bracket.

It will be appreciated by those skilled in the art that the effects achievable through the invention are not limited to those that have been particularly described hereinabove, and other effects of the invention will be more clearly understood from the above detailed description.

The present invention has been described above with reference to an exemplary embodiment. It is to be understood that the phraseology and terminology used in this specification and the appended claims should not be construed as being limited to general or dictionary meanings. The embodiment described in the specification and shown in the accompanying drawings is illustrative only and is not intended to represent all aspects of the invention. Therefore, the present invention is not limited to the embodiment presented herein, and it is to be understood by those skilled in the art that various modifications or changes can be made without departing from the technical spirit and scope of the invention as disclosed in the appended claims.

What is claimed is:

1. A double-folding unlocking device of a rear seat for a vehicle, the double-folding unlocking device comprising:
a cushion hinge bracket mounted to a rear portion of a seat cushion frame so as to rotate integrally with the seat cushion frame;
a lever bracket assembled to the cushion hinge bracket so as to be rotatable about a first rotation shaft;
a link bracket having a lower portion, rotatably linked to an upper arm of the lever bracket, and an upper portion, formed to be interlocked with rotation of a back hinge bracket mounted to a lower portion of a seatback frame; and
a latch release cable assembly linked at a rear end thereof to a front arm of the lever bracket to unlock the seat cushion frame from a floor panel of a vehicle body when the lever bracket rotates.

2. The double-folding unlocking device of claim 1, wherein the lower portion of the link bracket is linked to the upper arm so as to be rotatable about a second rotation shaft assembled to the upper arm.

3. The double-folding unlocking device of claim 2, wherein the upper portion of the link bracket is provided with a hinge pin at a position opposite the second rotation shaft, wherein, when the back hinge bracket rotates, the hinge pin is pushed and moved by a lower portion of the back hinge bracket.

4. The double-folding unlocking device of claim 2, wherein the lever bracket is provided with a latching piece formed at an upper end of the upper arm,
wherein, when the back hinge bracket rotates in a folding direction of a seatback, the link bracket catches on the latching piece and rotates integrally with the lever bracket.

5. The double-folding unlocking device of claim 4, wherein, when the back hinge bracket rotates in an unfolding direction of the seatback, the link bracket does not catch on the latching piece and rotates about the second rotation shaft.

6. The double-folding unlocking device of claim 1, further comprising:
a lever-returning spring having an upper end linked to the front arm of the lever bracket and a lower end linked to the cushion hinge bracket,
wherein, when the lever bracket rotates together with the link bracket, the lever-returning spring generates elastic restoring force.

7. The double-folding unlocking device of claim 4, further comprising:
a link-returning spring fitted around the second rotation shaft, the link-returning spring having one end linked to the link bracket and an opposite end linked to the latching piece,
wherein, when the link bracket rotates about the second rotation shaft, the link-returning spring generates elastic restoring force.

8. The double-folding unlocking device of claim 6, wherein the lever bracket is provided with a rear arm formed opposite the front arm with respect to the first rotation shaft,
wherein, when the lever bracket is returned by the lever-returning spring, the rear arm comes into contact with a stopper formed at the cushion hinge bracket and stops moving.
